(19) United States
(12) Patent Application Publication
(10) Pub. No.: US 2023/0001525 A1
(43) Pub. Date: Jan. 5, 2023

(54) MACHINE TOOL HAVING AT LEAST TWO TOOL CHANGING SYSTEMS

(71) Applicant: P&L GMBH & CO. KG, Soltau (JP)

(72) Inventor: Jürgen RÖDERS, Soltau (DE)

(21) Appl. No.: 17/782,145

(22) PCT Filed: Nov. 16, 2020
(86) PCT No.: PCT/EP2020/082258

§ 371 Date: Jun. 2, 2022

(30) Foreign Application Priority Data
Dec. 11, 2019 (DE) 10 2019 219 340.4

(51) Int. Cl. B23Q 3/155

(52) U.S. Cl. CPC B23Q 3/15539; B23Q 2003/155453; B23Q 2003/155456

(57) ABSTRACT

The invention relates to a machine tool including a main spindle, a machine frame, a first tool changing system for tools having a first diameter, a second tool changing system for tools having a second diameter, wherein a minimum second diameter of the tools of the second tool changing system is larger than a maximum first diameter of the tools of the first tool changing system, and wherein the second tool changing system is integrated into the machine frame.

The present invention relates to a machine tool having at least two tool changing systems, especially in order to be able to handle tools having different dimensions in a simple manner.

Machine tools, such as milling machines, often have a tool changing system to allow machining of a workpiece using different tools, wherein tool changing of a tool into the main spindle is performed automatically. With such tool changing systems, there is an issue in that a compromise is to be found between a necessary space requirement, a number of tools to be accommodated and the maximum dimensions of the tools. The larger the dimensions of the tools, especially with regard to their diameter, the fewer tools fit into the tool changing system.

In practice, it has now been shown that in many applications, not many tools are in use that have large dimensions, whereas most of the tools that are commonly used are significantly smaller. If all tool insert locations in the tool changing system are provided such that the few large tools also fit thereinto, space requirement for such a tool changing system becomes very large.

It is therefore an object of the present invention to provide a machine tool having automated tool changer which, while being of simple design and simple and low-cost manufacturability, is also able to hold a certain number of large tools in addition to a large number of smaller tools, without resulting in the dimensions and the installation space required to become too large.

This object will be solved by providing a machine tool having the features of claim 1, whereas the subclaims show preferred further embodiments of the invention.

The machine tool according to the invention having the features of claim 1 has the advantage that a more compact design of tool changing systems will be realized. Herein, the machine tool comprises a main spindle and a machine frame as well as at least two tool changing systems. A first tool changing system is provided for tools having a first diameter and a second tool changing system is provided for tools having a second diameter, wherein a second minimum diameter of the second tool changing system is larger than a maximum first diameter of the tools of the first tool changing system, thus integrating the second tool changing system into the machine frame. As a result, an installation space for the second tool changing system, which accommodates the larger tools, is integrated into the machine frame such that the first tool changing system, which accommodates the smaller tools, occupies significantly less installation space. As a result, a machine tool can be provided which is significantly more compact than in the prior art.

Preferably, the second tool changing system is arranged in a cavity or recess or the like in the machine frame. This means that no additional space is required for the second tool changing system in the machine tool, since a cavity provided in the machine frame serves to accommodate the second tool changing system.

Particularly preferably, each magazine location of the second tool changing system comprises a cylinder, especially a pneumatic cylinder, a holding arm and a gripper. This allows achieving particularly cost-effective and robust design. The gripper is arranged to grip a tool. The gripper is preferably arranged at one end of the holding arm, wherein the cylinder actuates the holding arm, preferably in a linear direction.

The gripper is preferably arranged at an angle of 90° to the holding arm. Further preferably, the pneumatic cylinder is designed without a piston rod.

A particularly simple and compact design of the second tool changing system will be realized with the main spindle of the machine tool being movable in the direction of a vertical axis and a horizontal axis. This allows the main spindle to be moved within a single plane of movement, such that simple and fast transfer of a tool to be exchanged will be provided. The second tool changing system is preferably movable exclusively linearly in a horizontal direction. This results in three-dimensional movability between the main spindle and the second tool changing system.

Particularly preferably, the machine tool is a machine tool having portal design including a first and second column as well as a transverse portion connecting the columns. Preferably, the second tool changing system is arranged on an underside of the transverse portion. Alternatively, the second tool changing system is provided in a recess in the transverse portion and/or in one of the columns.

To provide most effective arrangement of the tools of the second tool changing system, the magazine positions in the second tool changing system are arranged horizontally next to each other.

According to another preferred embodiment of the invention, the second tool changing system is arranged to perform change of tool in a machining space. Thus, movability of the main spindle can be limited to the machining space and the main spindle is not required to leave the machining space to perform change of tool.

Particularly preferably, a housing, preferably including a closable opening, e.g. by means of a flap, is provided which protects the second tool changing system. Thus, the second tool changing system is safely arranged in the housing when operating the machine tool and will not be contaminated by chips or coolant or the like when running the machine tool.

Further preferably, a number of magazine locations for the tools in the second tool changing system is smaller than in the first tool changing system. Preferably, two or three magazine locations are provided for the second tool changing system.

In the following, a preferred example embodiment will be described in detail while making reference to the accompanying drawing, wherein:

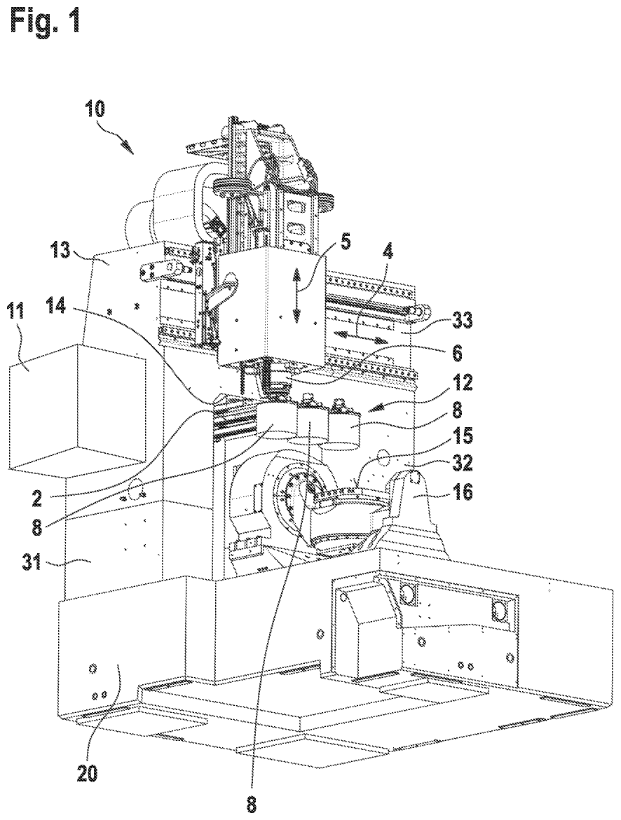

FIG. 1 is a schematic perspective view of a machine tool having two tool changing systems, wherein the second tool changing system is in the extended position,

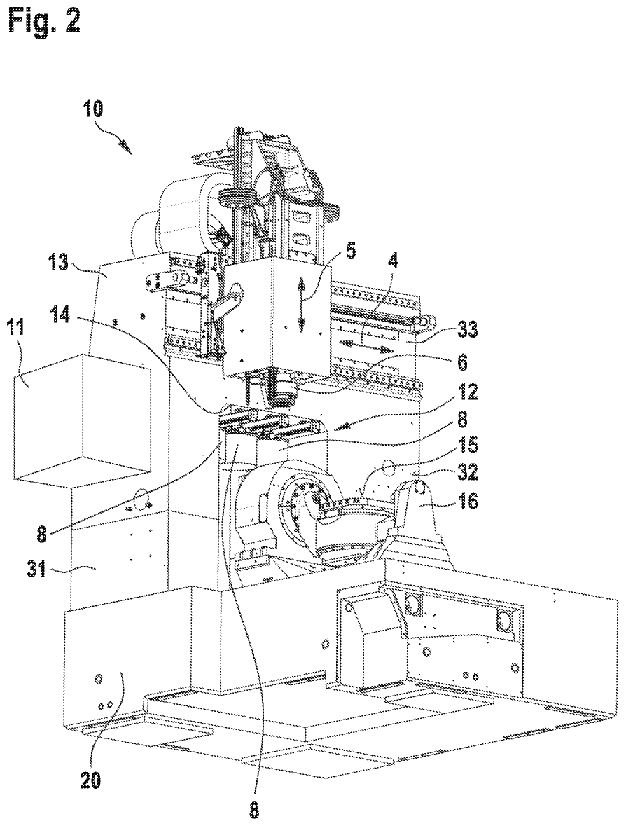

FIG. 2 is a schematic perspective view of the machine tool of FIG. 1 being in a retracted position of the second tool changing system,

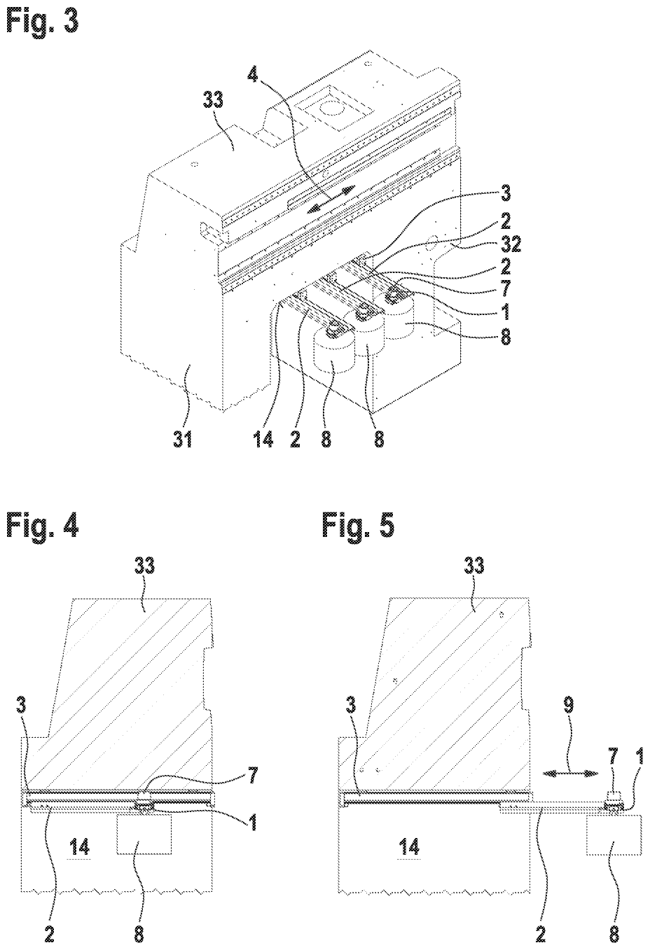

FIG. 3 is a schematic perspective view of a machine frame with the second tool changing system being in the extended position,

FIG. 4 is a schematic sectional view of the machine frame with the second tool changing system being in the retracted position, and

FIG. 5 is a schematic sectional view of the machine frame with the second tool changing system being in the extended position.

In the following, a machine tool 10 according to a preferred embodiment of the invention will be described in detail while reference will be made to FIGS. 1 to 5.

The machine tool 10 comprises a main spindle 6 which is movable in the direction of a horizontal axis 4 and a vertical axis 5.

The machine tool 10 further comprises a machine frame 13, which, in this embodiment, is of portal design. The machine frame 13 comprises a first column 31, a second column 32 and a transverse portion 33, the main spindle 6 being movable in the horizontal direction at the transverse portion 33.

The machine frame 13 is arranged on a base plate 20, on which a rotary swivel unit 16 is movable along another horizontal axis not shown. A grooved plate 15 can be seen on the rotary swivel unit 16, onto which grooved plate workpieces can be clamped.

Furthermore, a first tool changing system 11 and a second tool changing system 12 are provided. The first tool changing system 11 is provided for first tools having a first diameter and the second tool changing system 12 is provided for second tools having a second diameter, wherein a maximum first diameter of the first tools is smaller than a minimum second diameter of the second tools. Thus, the second tool changing system is provided for larger diameter tools, whereas the first tool changing system is provided for smaller diameter tools.

As can be seen from FIGS. 1 and 2, the first tool changing system 11 is arranged laterally on the machine frame 13. The second tool changing system 12 is arranged in a cavity 14 of the machine frame 13. The cavity 14 is provided below the transverse portion 33 of the machine frame 13.

The design of the second tool changing system 12 is shown in detail in FIGS. 3 to 5. The second tool changing system 12 comprises three magazine positions, which are arranged next to each other. The second tools are designated by the reference number 8, and have a relatively large diameter. Each machine insert location further comprises a pneumatic cylinder 3, a holding arm 2 and a gripper 1. The pneumatic cylinder 3 is rodless and linearly moves the holding arm 2 in a horizontal direction 9, the horizontal direction 9 being perpendicular to the horizontal axis 4 and perpendicular to the vertical axis 5.

The gripper 1 is used to hold a tool holder 7, which holds the tool 8. The gripper 1 can engage in a groove not shown or can engage in flattening in the tool holder 7, such that the tool holder together with the tool 8 can laterally be removed in the extended position, since the gripper 1 is arranged at an angle of 90° to the holding arm 2.

FIG. 1 schematically shows the extended position of all three magazine positions. It should be noted that in practical operation, of course, only one magazine position is extended and the other two magazine positions are in the retracted position shown in FIGS. 2 and 4.

As may especially be seen from FIG. 1, a tool change position for a tool is located in the machining compartment of the machine tool 10. As may further be seen from FIGS. 1 and 2, the tool change position is located vertically above the grooved plate 15 or the rotary swivel unit 16.

Since the main spindle 6 is movable in two linear directions (vertical and horizontal axis 4, 5) and the second tool changing system 12 is movable in a horizontal direction 9, this results in a spanned three-dimensional space in which the tools can be changed. In the retracted position of the tools 8 in the second tool changing system 12, the tools 8 are thus located outside the machining compartment below the transverse portion 33 of the portal-like machine frame 13.

To change a tool 8, the machine tool can thus position the main spindle 6 above the extended second tool holder 7 by moving in the direction of the two machine axes (vertical and horizontal axes 4, 5) and then moving down therefrom onto the tool holder 7, clamping it by the main spindle 6.

After the tool holder 7 has been clamped in the main spindle 6, the tool holder 7 can be extended laterally from the gripper 1 by moving the main spindle 6 linearly in the horizontal axis 4. As soon as sufficient distance to the gripper 1 has been achieved by laterally moving, the gripper 1 may be returned into the rest position beneath the transverse portion 33 with the holding arm 2. As a result, the gripper 1 and the holding arm 2 have moved out of the machining compartment of the machine tool 10 and machining using the newly clamped tool 8 may be started.

Thus, very few parts are required to accommodate the second tool changing system 12 which includes the large diameter tools. Furthermore, especially control during tool changing can be performed in a simple and easy manner. As a result, a very short tool changing time can also be achieved.

In the example embodiment illustrated, three magazine positions of the second tool changing system 12 are shown. However, it should be noted, that it is of course also possible to provide further additional magazine positions or even to only provide two or one magazine position. In this case, each individual magazine position can separately be controlled so as to move from its rest position to the changing position in the machining compartment by moving the pneumatic cylinder 3.

Thus, any distance between separate magazine positions is defined by a maximum diameter of the tools 8.

It should be further noted that, of course, a machine tool, such as a gantry machine, may be provided in which a main spindle is movable in the direction of more than two axes. In that case, the gripper 1 of the second tool changing system 12 need not necessarily be attached to the holding arm 2 at a right angle, but may be arranged on the holding arm 2 in any direction.

It should also be noted that the second tool changing system 12 may also be protected from chips produced during the machining process and from coolant or the like by an enclosure. For example, a flap may be arranged in front of the recess 14 to protect the second tool changing system 12.

### LIST OF REFERENCE NUMBERS

1 gripper
2 holding arm
3 rodless pneumatic cylinder
4 horizontal axis/first horizontal direction
5 vertical axis
6 main spindle
7 tool holder
8 tool
9 horizontal axis/second horizontal direction
10 machine tool
11 first tool changing system
12 second tool changing system
13 machine frame/portal
14 cavity
15 grooved plate
16 rotary swivel unit
20 base plate
31 first column
32 second column
33 transverse portion

1. A machine tool, comprising:
a main spindle,
a machine frame,
a first tool changing system for tools having a first diameter,
a second tool changing system for tools having a second diameter,
wherein a minimum second diameter of the tools of the second tool changing system is larger than a maximum first diameter of the tools of the first tool changing system, and
wherein the second tool changing system is integrated into the machine frame.

2. The machine tool according to claim 1, wherein the second tool changing system is arranged in a cavity in the machine frame.

3. The machine tool according to claim 1, the second tool changing system comprises a plurality of magazine positions, each magazine position comprising a movable cylinder, especially a pneumatic cylinder, a holding arm and a gripper.

4. The machine tool according to claim 3, wherein the gripper is arranged on the holding arm at an angle of 90°, and/or wherein the cylinder is designed as a pneumatic cylinder without a piston rod.

5. The machine tool according to claim 1, wherein the main spindle is movable in a vertical axis and a horizontal axis.

6. The machine tool according to claim 1, wherein the machine tool is of portal design having a first column, a second column and a transverse portion connecting the columns.

7. The machine tool according to claim 6, wherein the second tool changing system is arranged beneath the traverse portions and/or wherein a recess is provided in the transverse portion.

8. The machine tool according to claim 1, wherein the magazine positions of the second tool changing system are arranged horizontally next to each other.

9. The machine tool according to claim 1, wherein the second tool changing system is arranged to perform a tool change in a machining compartment of the machine tool.

10. The machine tool according to claim 1, wherein a number of magazine positions for the tools in the second tool changing system is smaller than a number of magazine positions for the tools of the first tool changing system.
